(19) United States
(12) Patent Application Publication
(10) Pub. No.: US 2016/0092840 A1
(43) Pub. Date: Mar. 31, 2016

(54) FORECASTING JOB APPLICANT DATA FOR A JOB POSTING

(71) Applicant: LinkedIn Corporation, Mountain View, CA (US)

(72) Inventors: Eduardo Vivas, Miami, FL (US); Deniz Kahramaner, Mountain View, CA (US); Deepak Kumar, Mountain View, CA (US); Jieying Chen, Sunnyvale, CA (US); Onkar Anant Dalal, Sunnyvale, CA (US); Vibhu Prakash Saxena, Milpitas, CA (US)

(21) Appl. No.: 14/557,346

(22) Filed: Dec. 1, 2014

Related U.S. Application Data
(60) Provisional application No. 62/058,014, filed on Sep. 30, 2014.

(51) Int. Cl. G06Q 10/10; G06F 17/30

(52) U.S. Cl. CPC G06Q 10/1053; G06F 17/30345

(57) ABSTRACT

Techniques for upselling a limited job posting to a premium job posting are described. A determination module can access job listing data from a limited job. Additionally, the determination module can access member data from a social network. Furthermore, the determination module can determine a value for the limited job posting based on the accessed job listing data and the accessed member data. Moreover, the determination module can generate a job application based on the accessed job listing data and the accessed member data, when the determined value is above a predetermined threshold. Subsequently, the determination module and an upsell module can upsell the limited job posting to a premium job posting by using the generated job application data. In some instances, the upsell module can market to the job poster in order to upsell the limited job listing, and fill empty job slots already paid by the job poster.

This application claims the priority benefit of U.S. Provisional Application No. 62/058,014, filed Sep. 30, 2014.

### TECHNICAL FIELD

The subject matter disclosed herein generally relates to data processing systems for hosting job postings. Specifically, the present disclosure generally relates to techniques for forecasting job applicant data for a job posting.

### BACKGROUND

With a typical job hosting service, a representative of a company will post a job listing to the job hosting service so that users of the job hosting service can search for, browse, and in some cases, apply for the job associated with the particular job listing. In exchange for making the job listing available for presentation to the users of the job hosting service, the company on whose behalf the job listing is posted will typically pay a fee.

Additionally, social network systems can maintain information on members, companies, organizations, employees, and employers. The social media and networking websites may also include a job hosting service, which can include job postings for a potential employer. In some instances, a paid job posting can be listed directly on the social network site, and an unpaid job posting can be received from a third-party website. The job posting can include the employer and location associated with the job. However, some useful marketing information may be missing or otherwise unavailable in the job posting, such as the identity of the representative that listed the job posting.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network, according to some example embodiments.

FIG. 2 is a block diagram illustrating various modules of a social network service, according to some embodiments.

FIG. 3 is a flowchart illustrating a method for upselling a limited job posting to a premium job posting on a social network site, according to some example embodiments.

FIG. 4 illustrates a chart with some of the factors for determining the company brand index, according to some embodiments.

FIG. 5 is a flowchart illustrating a method for upselling a job listing, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

In a social network system, social graph information and member behavior data are based on member profiles and company pages. For example, a member of a social network can create a member profile. The member profile can include a location associated with the member, a company listed as the member's current employer, and the member's job title. In addition to member profiles, a social network system can have job postings with information relating to an available job at a certain company. The job posting can either be a limited job listing (e.g., unpaid) or a premium job listing (e.g., paid).

Consistent with some embodiments, a job hosting service of a social network system can have bifurcated functions and features for paid and unpaid job listings (sometimes referred to as job postings), such that paid job postings are subject to the benefits of a first set of functions and features, while unpaid job postings are subject to the benefits of a second set of functions and features. With some job hosting services, different price points may provide different benefits in terms of how the job listing is handled.

For example, via a job posting module of the job hosting service, users of the job hosting service can provide information about a particular job opening and generate a paid job listing. A job listing typically is comprised of the name of the company or organization at which the job opening is available, the job title for the job opening, a description of the job functions, and the specified recommended skills, education, certifications, and/or expertise. In exchange for the payment of the fee, the paid job posting will be eligible for presentation to members of a social networking service with which the job hosting service is integrated.

In addition to paid job postings, the job hosting service may ingest job listings from various externally hosted third-party job sites. In some instances, an automated bot may automatically “crawl” and discover job listings for ingestion, while in other instances, job listings may be obtained from a data feed maintained by one or more third-party partners. In any case, the job hosting service will have a database containing both paid job listings—that is, job listings that have been generated through a job posting module and for which a fee has been obtained—and, unpaid job listings—that is, job listings obtained from a third-party site.

With some embodiments, the unpaid job postings are only eligible for presentation to members of a social networking service through a job search interface. Accordingly, the unpaid or free job listings will typically only be presented to members that might be referred to as active job seeking candidates or active job seekers. These active job seekers are members who are typically actively engaged in the process of looking for new career opportunities. The paid job postings are also eligible for presentation to members of the social networking service through the search interface, but are also presented to members through various other channels. For example, a job recommendation engine may match member profiles with job listings with the objective of presenting a member of the social networking service with a number of relevant job listings—that is, job listings that might be of interest to the member, based on that member's profile data.

The present disclosure describes methods, systems, and computer program products for forecasting job applicant data for a job posting. Using social graph information and member behavior data in the social network system, embodiments of the present disclosure can determine job applicant data for a specific job posting. In some instances, the job applicant data associated with an unpaid job posting can be used to upsell the job poster to upgrade to a paid job posting. Social graph information and member behavior data can be used to determine job applicant data that is not easily ascertained such as the expected number of applicants for the premium (e.g., paid) and limited (e.g., unpaid) job posting, the expected number of views for the premium and limited job posting, and so on.

According to some embodiments, when a job poster is viewing an unpaid job posting, various predictive analytics can be displayed to the job poster to upsell the limited job posting to a premium job posting. Using job listing data (e.g., job features, job activity tracking features, and company features), the determination module, which is a module in a social network system, can identify specific job postings that are forecasted to perform better by switching from limited listing to premium job posting. The determination module can determine job applicant data (e.g., the number of applicants, views, and impressions) for the limited job postings.

Based on the job listing data, the determination module can determine (e.g., classify) which limited job postings to upsell to a premium job posting. In some instances, the job posting can be classified for upselling based on a value (e.g., numeric value) corresponding to the job applicant data being above a predetermined threshold. Additionally, the determination module can improve to a finer-grained prediction (e.g., by having multiple thresholds) of specific parameters (e.g., number of job applicants, number of views, and impressions) for more accurate forecasting. Furthermore, the determination module can determine real-time forecasting and prediction for the limited listings. The real-time forecasting and prediction can include numeric data (e.g., percentage increase of applicants, number of additionally applicants) when upgrading to a premium job posting based on the job applicant data.

Additionally, the social network system can create a data model associated with the job posting. The data model can include company, industry, location, job title, and seniority information. The data model can be used to determine the numerical or percentage increase that a limited listing will get when it is upgraded to a premium listing.

For example, the data model can include statistical evidence on a per-company basis to use in marketing the premium job listing. Additionally, the data model can include a specific list of limited listings, such as the limited listings with job applicant data that are above the threshold value. By specifically targeting a specific list of limited listings, the social network system can ensure that a potential customer (e.g., job poster) can receive a good return on investment (ROI). By selecting specific limited listings that are likely to perform well, the selection can help provide consistent ROI to potential customers, and improve repeat upsell behavior.

Additionally, the data model can utilize the data to develop a new and powerful set of in-product upsells for limited listings by clearly demonstrating the percentage uplift a limited listing will get in specific parameters (e.g., number of job applicants, number of views, and impressions) if converted to a premium job listing.

The job application data can include primary metrics and secondary metrics. In the primary metrics, for each premium listing that was upsold from a “sure upsell” limited listing, the determination module can compare between actual number of applicants and threshold. Additionally, using machine-learning techniques, the data can be used to improve the model. Furthermore, the primary metrics can include the number of paid job upsells (e.g., on a daily or weekly basis) in online and offline mode. Moreover, the primary metrics can include the number of repeat job upsells (e.g., on a daily or weekly basis) in online and offline mode after a specific amount of time (e.g., 30 days) after the first upsell for an account.

In some instances, for each limited job postings, the determination module can determine a numeric value based on the country of the job posting, the region of the job posting, the standardized job title, the job functions, the industry associated with the company, the company size, and a company brand index (e.g., popularity of company brand). When the numeric value is above a predetermined threshold, the determination module can classify the job posting as a “sure upsell” posting. Alternatively, the determination module can return a score based on the likeliness of exceeding the threshold. For each “sure upsell” limited listing identifier (ID), the determination module can be further configured to calculate the ratio between the threshold and the current number of applicants, views, and impressions. The calculated ratio can be the percentage increase in applicants for that limited listing.

According to another embodiment, a specific company may have a predetermined number of premium listings that have been pre-paid. For example, Company A can have 100 premium listings at a given time, but only 90 of the premium listing slots are filled. Therefore, the determination module can determine a subset of job posting that are going to perform well as premium jobs based on the job applicant data. In some instances, the determination can further be based on the number of available premium listing slots.

According to some embodiments, the determination module can determine whether the limited posting is a “sure upsell” limited listing based on the company features, the job activity tracking, and the job features.

The premium listing (e.g., paid job posting) can include features and channels to allow for a higher likelihood of finding a job candidate for the job postings in comparison with a limited listing (e.g., unpaid job posting). For example, a limited listing may have some features disabled, such as sharing ability, editing ability, and talent branding.

Additionally, a paid job posting can be a sponsored job listing. In some instances, an upsell module can determine members in the social network system that are good matches for the sponsored job listing, and present the determined members list of jobs that can be of interest. For example, a periodic email can be sent to members with sponsored jobs that are good match. A good match can be based on education, location, job skills, member skills, and so on.

Alternatively, a premium listing can have a larger job applicant reach, a premium placement in the search, targeted placement across the social network system, recommendation to potential job applications, analytics, and talent matching features.

The determination module can determine value based on job listing data (e.g., estimate increase in impressions, view, and applicants) when the limited job listing is upgraded to a premium job listing. Additionally, the determination module can use the member data and the job listing data for talent matching.

The determination module can run regression models based on the company features, job features, and job activity tracking features to determine which limited listings to upsell to premium listings.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

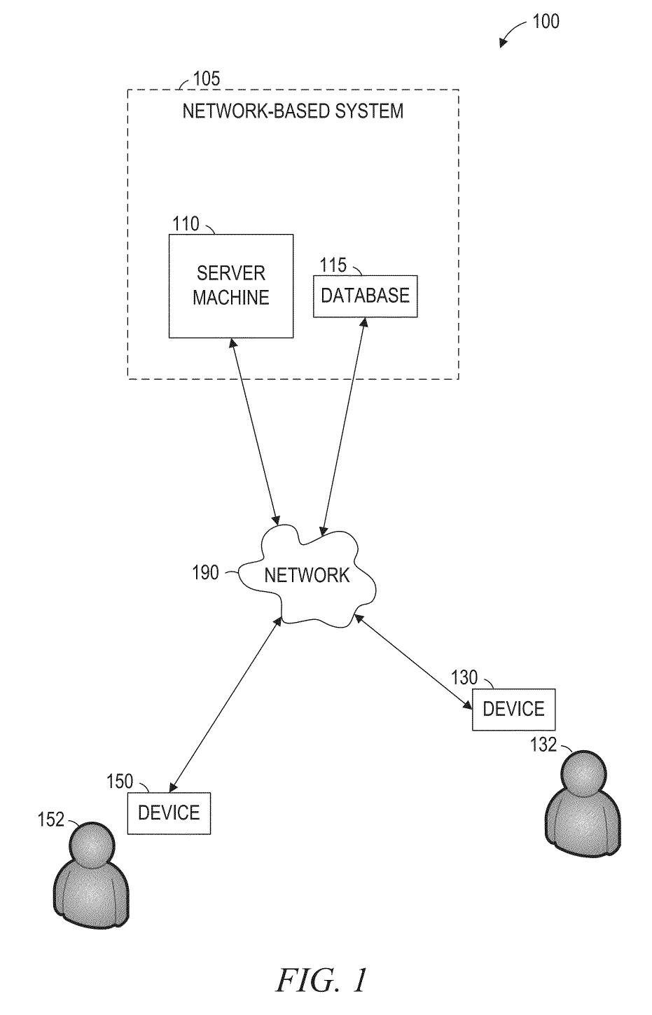

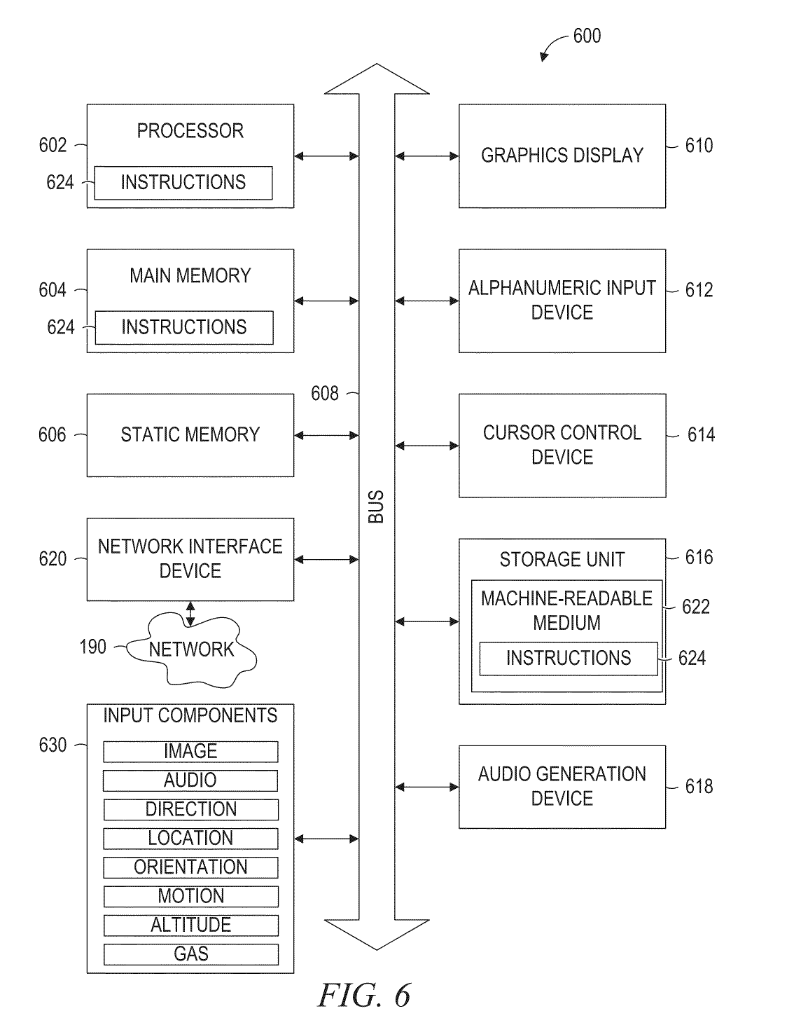

FIG. 1 is a network diagram illustrating a network environment 100 suitable for a social network service, according to some example embodiments. The network environment 100 includes a server machine 110, a database 115, a first device 130 for a first user 132, and a second device 150 for a second user 152, all communicatively coupled to each other via a network 190. The server machine 110 may form all or part of a network-based system 105 (e.g., a cloud-based server system configured to provide one or more services to the devices 130 and 150). The database 115 can store job listings for the social network service. The server machine 110, the first device 130, and the second device 150 may each be implemented in a computer system, in whole or in part, as described below with respect to FIG. 6.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

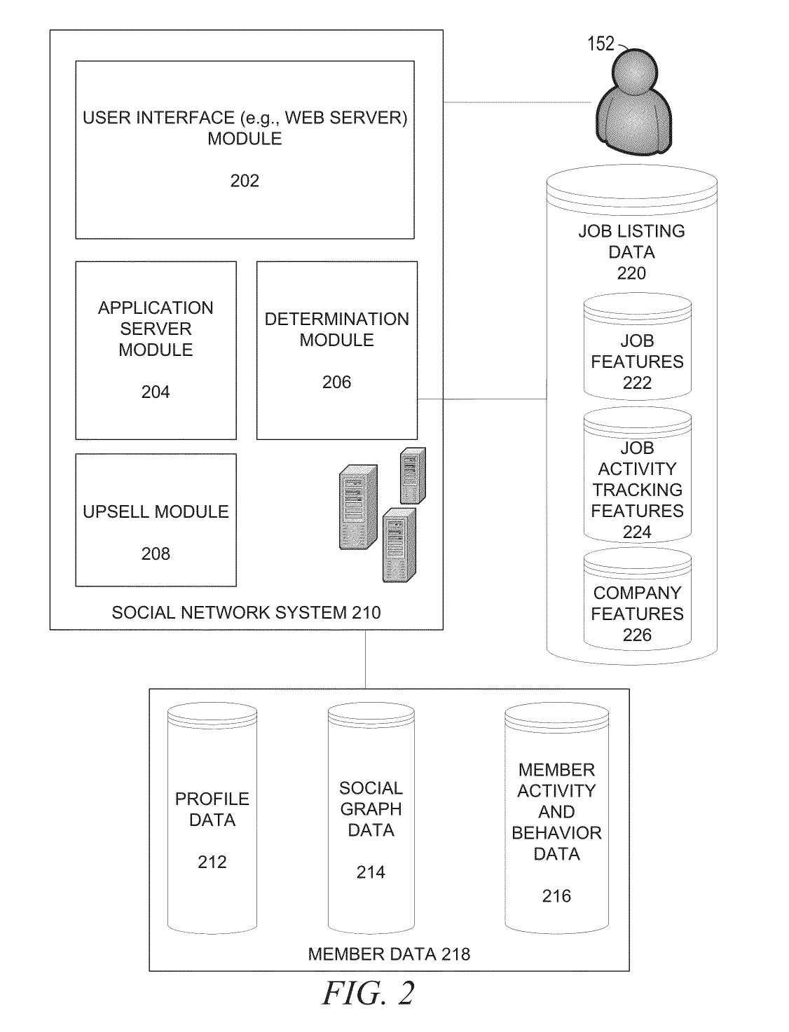

FIG. 2 is a block diagram illustrating components of a social network system 210, according to some example embodiments. The social network system 210 is an example of a network-based system 105 of FIG. 1. The social network system 210 can include a user interface module 202, an application server module 204, a determination module 206, and an upsell module 208, all configured to communicate with each other (e.g., via a bus, shared memory, or a switch).

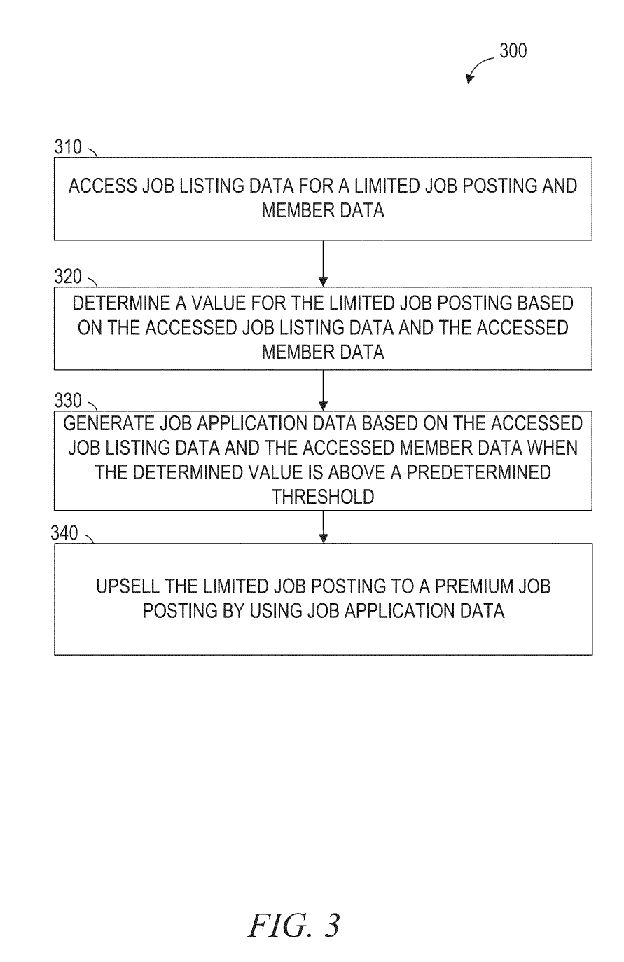

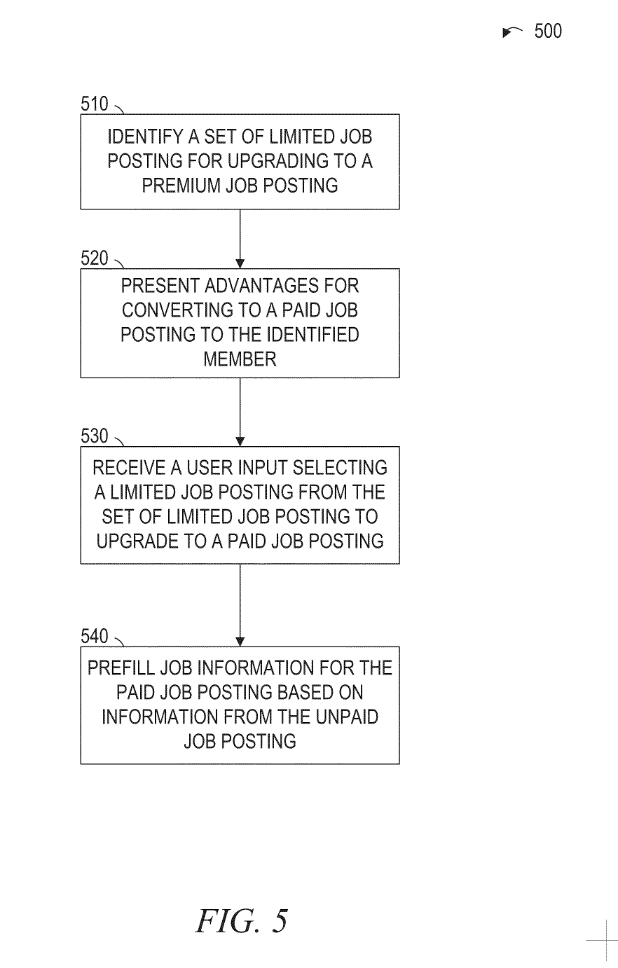

The user interface module 202 can present a job listing, accessed from job listing data 220, to a user 152. As described in FIG. 3, the determination module 206 can use information available (e.g., member data 218, job listing data 220) to determine if the limited job listing is to be upsell to a premium job listing. As described in FIG. 5, when it is determined that the job posting is classified for upselling, then the upsell module 208 can upsell the representative to upgrade the job listing to a paid job listing.

Furthermore, the social network system 210 can communicate with database 115 of FIG. 1, such as a database storing member data 218 and job listing data 220. The member data 218 can include profile data 212, social graph data 214, member activity and behavior data 216. The job listing data can include job features 222, job activity tracking features 224, and company features 226. Using the member data 218 and the job listing data 220, determination module 206 can determine whether to upsell the limited job listing. Additionally, using the member data 218 and the job listing data 220, upsell module 208 can upsell the representative to upgrade to a paid job posting.

In some instances, the determination module 206 can be configured to process data offline or periodically. For example, the determination module 206 can include Hadoop servers that access member data 218 and job listing data 220 periodically in order for the upsell module 208 to periodically upsell the representative associated with the unpaid posting (e.g., via email). Processing the member profile data may be computationally intensive; therefore, due to hardware limitations and to ensure reliable performance of the social network, the determination may be done offline.

As will be further described with respect to FIG. 3 and FIG. 5, the determination module 206 and upsell module 208, in conjunction with the user interface module 202 and the application server module 204, can determine the unpaid job posting to upsell to a representative to upgrade to a paid job posting using member data 218 and job listing data 220.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

As shown in FIG. 2, the block diagram includes several databases, such as a database for member data 218 for storing profile data 212, including both member profile data as well as profile data for various organizations. Additionally, the database for member data 218 can store social graph data 214, member activity and behavior data 216, job features 222, job activity tracking features 224, and company features 226.

Profile data 212 can be used to determine entities (e.g., company, organization) associated with a member. For instance, with many social network services, when a user registers to become a member, the member is prompted to provide a variety of personal and employment information that may be displayed in a member's personal web page. Such information is commonly referred to as profile data 212. The profile data 212 that is commonly requested and displayed as part of a member's profile includes a person's age, birthdate, gender, interests, contact information, residential address, home town and/or state, the name of the person's spouse and/or family members, educational background (e.g., schools, majors, matriculation and/or graduation dates, etc.), employment history, office location, skills, professional organizations, and so on.

In some embodiments, profile data 212 may include the various skills that each member has indicated he or she possesses. Additionally, profile data 212 may include skills for which a member has been endorsed in the profile data 212. Using the skills, determination module 206 can determine if the member is a recruiter or an executive of a company. In some instances, a recruiter or an executive of a company can be the representative of the company that listed the job listing.

In some other embodiments, with certain social network services, such as some business or professional network services, profile data 212 may include information commonly included in a professional resume or curriculum vitae, such as information about a person's education, the company at which a person is employed, the location of the employer, an industry in which a person is employed, a job title or function, an employment history, skills possessed by a person, professional organizations of which a person is a member, and so on.

Another example of profile data 212 can include data associated with an entity page (e.g., company page). For example, when a representative of an entity initially registers the entity with the social network service, the representative may be prompted to provide certain information about the entity. This information may be stored, for example, in the database 115, and displayed on an entity page.

Using the skills, job title, job function, and industry information in the profile data 212, the determination module 206 can determine if the member is a recruiter or an executive of a company. In some instances, a recruiter or an executive of a company can be the representative of the company that listed the job listing.

Additionally, social network services provide their users with a mechanism for defining their relationships with other people. This digital representation of real-world relationships is frequently referred to as a social graph.

In some instances, social graph data 214 can be based on an entity's presence within the social network service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations and/or relationships between the different entities.

Once registered, a member may invite other members, or be invited by other members, to connect via the social network service. A “connection” may have a bilateral agreement by the members, such that both members acknowledge the establishment of the connection. The connection relationship data can be stored in the social graph data 214.

Furthermore, the social graph data 214 can be maintained by a third-party social network service. For example, users can indicate a relationship or association with a variety of real-world entities and/or objects. Typically, a user input is captured when a user interacts with a particular graphical user interface element, such as a button, which is generally presented in connection with the particular entity or object and frequently labelled in some meaningful way (e.g., “like,” “+1,” “follow”).

Referring back to FIG. 2, in addition to hosting a vast amount of social graph data 214, many social network services maintain member activity and behavior data 216.

In some instances, the determination module 206 can be further configured to determine whether the limited posting is a “sure upsell” limited listing based on job listing data 220. The job listing data can include company features 226, the job activity tracking 224, and the job features 222.

The job features 222 can include country and region associated with the job posting, the standardized job title and the job functions.

The job activity tracking features 224 include the job application information, the job apply feature, the job impression feature, and the number of job views.

The company features 226 include information relating to company size, company industry, company size range, and company talent brand index. The company talent brand index can be based on the number of followers, the number of company page views, the number of company's career page views, the number of employee profile views, and the number of employee connections. In some instances, a subset of these features can yield a better forecasting model.

The social network service may provide a broad range of other applications and services that allow members the opportunity to share and receive information, often customized to the interests of the member. In some embodiments, members may be able to self-organize into groups, or interest groups, organized around subject matter or a topic of interest. In some embodiments, the social network service may host various job listings providing details of job openings with various organizations.

Member activity and behavior data 216 can include members' interaction with the various applications, services, and content made available via the social network service, and the members' behavior (e.g., content viewed, links selected, etc.) may be used to determine the specific member that listed the job posting.

FIG. 3 is a flowchart illustrating operations of determination module 206 in performing a method 300 for determining whether a limited posting is a “sure upsell” limited listing, according to some example embodiments. Operations in the method 300 may be performed by network-based system 105, using modules described above with respect to FIG. 2. As shown in FIG. 3, the method 300 includes operations 310, 320, 330, and 340.

According to some embodiments, the job applicant data associated with an unpaid job posting can be used to upsell the job poster to upgrade to a paid job posting. Social graph information and member behavior data can be used to determine job applicant data that is not easily ascertained such as the expected number of applicants for the premium (e.g., paid) and limited (e.g., unpaid) job posting, the expected number of views for the premium and limited job posting, and so on.

At operation 310, determination module 206 can access job listing data 220 for a limited job posting and member data 218. For example, when a job listing on the social network system 210 is a limited job posting (e.g., unpaid), the determination module 206 can access information related to the limited job posting.

At operation 320, the determination module 206 can determine a value for the limited job posting based on the accessed job listing data 220 and the access member data 218. The member data 218 and the job listing data 220 can be stored in database 115 and accessed by the determination module 206 using network 190.

For example, using job listing data 220 (e.g., job features, job activity tracking features, and company features), the determination module, which is a module in a social network system, can identify by using a numeric value specific job postings that are forecasted to perform better by switching from limited listing to premium job posting.

Based on the job listing data, the determination module can determine (e.g., classify) which limited job postings to upsell to a premium job posting. In some instances, the job posting can be classified for upselling based on a value (e.g., numeric value) corresponding to the job applicant data being above a predetermined threshold. Additionally, the determination module can improve to a finer-grained prediction (e.g., by having multiple thresholds) of specific parameters (e.g., number of job applicants, number of views, and impressions) for more accurate forecasting. Furthermore, the determination module can determine real-time forecasting and predictions for the limited listings. The real-time forecasting and predictions can include numeric data (e.g., percentage increase of applicants, number of additional applicants) when upgrading to a premium job posting based on the job applicant data. Alternatively, job application data from a premium job listing can be used to to predict limited job application data.

In some instances, a number of paid job posting are prepaid by the employer, and the predetermined threshold is based on a number of empty slots available from the number of paid job posting. For example, the predetermined threshold represents the number of limited listings that will be used to fill the empty slots out of all of the limited listings that belong to a company. To illustrate. Company A has 1000 limited listings that are ingested from the web, and when Company A has 30 empty slots, the determination module 206 can select 30 limited listings to be converted to a paid listing. The selection can be on the determination of which limited job posting are going to perform the best as a paid job posting.

Additionally, the social network system can create a data model associated with the job posting. The data model can include company, industry, location, job title, job function, and seniority information. The data model can be used to determine the numerical or percentage increase that a limited listing will get when it is upgraded to a premium listing.

For example, the data model can include statistical evidence on a per-company basis to use in marketing the premium job listing. Additionally, the data model can include a specific list of limited listings, such has the limited listings with job applicant data that are above the threshold value. By specifically targeting a specific list of limited listings, the social network system can ensure that a potential customer (e.g., job poster) can receive a good ROI. By selecting specific limited listings that are likely to perform well, the selection can help provide consistent ROI to potential customers and improve repeat upsell behavior.

In some instances, for each limited job posting, the determination module 206 can determine a numeric value based on the country of the job posting, the region of the job posting, the standardized job title, the job functions, the industry associated with the company, the company size, and a company brand index (e.g., popularity of company brand).

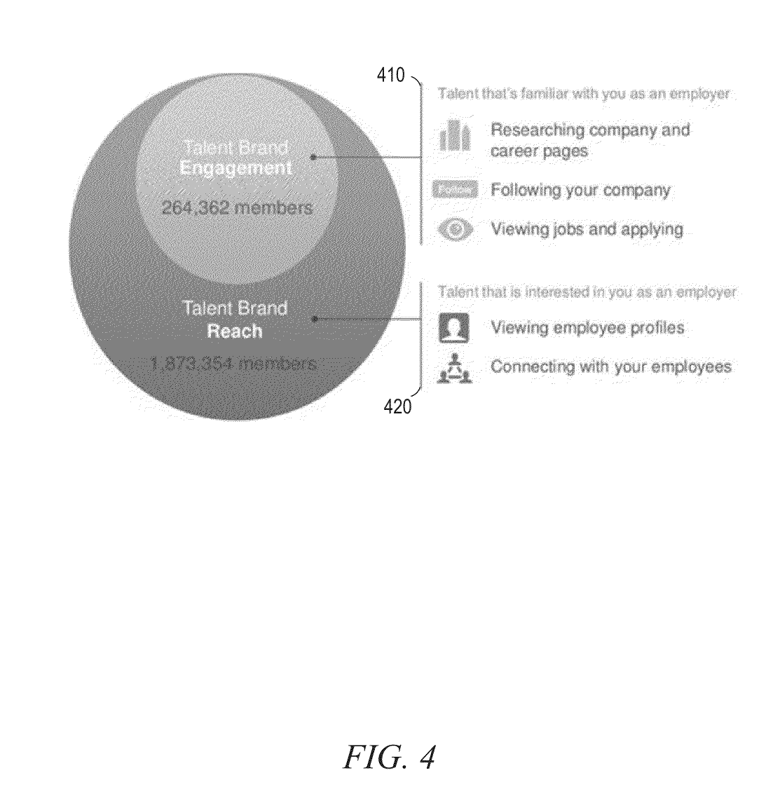

FIG. 4 illustrates a chart with some of the factors for determining the company brand index, according to some embodiments. The company brand index can be based on the popularity of a company, the number of members in the talent brand engagement group 410, and the number of members in the talent brand reach group 420. The talent brand engagement group 410 can include members that are researching the company and the career page of the company, members that are following the company, and members that are viewing and applying to job listings of the company. The talent brand reach group 420 can include members that are view the company's employee profile pages, and members that are connecting to the company's employees. Using the number of members in the talent brand engagement group 410 and the number of members in the talent brand reach group 420, the determination module 206 can calculate a company brand index.

Referring back to operation 320 of FIG. 3, when the numeric value is above a predetermined threshold, the determination module can classify the job posting as a “sure upsell” posting. Alternatively, the determination module can return a score based on the likeliness of exceeding the threshold. For each “sure upsell” limited listing ID, the determination module can be further configured to calculate the ratio between the threshold and the current number of applicants, views, and impressions. The calculated ratio can be the percentage increase in applicants for that limited listing.

For example, an applicant can be a member that submits application for a job posting. An impression can be an event when a member is presented a link to job with some brief job features (e.g., job title, and job company). A page view can be an event when a member clicks on a job link to land on the job page with complete job features (job title, job company, job description, and job requirements).

At operation 330, the determination module 206 can generate job application data based on the job listing data 220 and the member data 218, when the determined value from operation 320 is above a predetermined threshold. For example, the member data 218 can include any information derived from member activity on the social network system 210. Member activity can include the number of applicants on a job, the number of views on a job, and the number of impressions of job.

For example, the determination module 206 can use the accessed member data 218 and the accessed job listing data 220 to develop a new and powerful set of in-product upsells for limited listings by clearly demonstrating the percentage uplift a limited listing will get in specific parameters (e.g., number of job applicants, number of views, and impressions) if converted to a premium job listing.

The job application data can include primary metrics and secondary metrics. In the primary metrics, for each premium listing that was upsold from a “sure upsell” limited listing, the determination module can compare between actual number of applicants and the threshold. Additionally, using machine-learning techniques, the data can be used to improve the model. Furthermore, the primary metrics can include the number of paid job upsells (e.g., on a daily or weekly basis) in online and offline mode. Moreover, the primary metrics can include the number of repeat job upsells (e.g., on a daily or weekly basis), in online and offline mode after a specific amount of time (e.g., 30 days) after the first upsell for an account.

At operation 340, determination module 206 and the upsell module 208 can upsell the limited job posting to a premium job posting when the determined value is above a predetermined threshold. The determination module 206 can use the generated job applicant data (e.g., the number of applicants, views, and impressions) for the limited job postings, which can be used to upsell the limited job posting.

Alternatively, a premium listing can have a larger job applicant reach, a premium placement in the search, targeted placement across the social network system, recommendation to potential job applications, analytics, and talent matching features.

In some embodiments, the determination module 206 can determine a score value at operation 330. The upselling at operation 340 can be presented to the members with highest score. Additionally, a minimum threshold score value may be used in order to not target members with a lower likelihood of upgrading to the paid job posting.

Upselling can include sending marketing information to the identified member. Marketing information can be included in pop-up windows while the identified user is currently viewing the job listings. Additionally, marketing information can be included in emails sent periodically to the identified member. Marketing information includes information that can persuade the identified member to upgrade to the paid job listing on the social network system 210.

FIG. 5 is a flowchart illustrating a method 500 for upselling a paid job listing to an identified member, in accordance to another embodiment of the present disclosure. Operations in the method 500 may be performed by network-based system 105, using modules described above with respect to FIG. 2. As shown in FIG. 5, the method 500 includes operations 510, 520, 530, and 540.

At operation 510, upsell module 208 can identify a set of limited job postings to be upgraded to a premium job posting. The upsell module 208 can identify the set of limited job postings based on method 300.

At operation 520, upsell module 208 can present advantages for converting to a paid job posting to the identified member. Advantages can include the estimated number of qualified applicants a paid job posting can receive, the percentage increase in job applicants when converting an unpaid job posting to a paid job posting, and so on. In additional of presenting the percentage increase in net number of applicants, the determination module 206 and upsell module 208 can calculate and present the percentage increase in number of qualified applicants. Qualified applicants can be determined based on algorithms and machine-learning techniques using features of the social network system 210, such as the feature for determining the jobs that a member may be interested in.

At operation 530, upsell module 206 can receive a user input selecting a limited job posting from the set of limited job posting to upgrade to a paid job posting. For example, a user interface can be presented to a user with a set of limited job postings to upgrade. Subsequently, the user can select one of the limited job postings to upgrade to a paid job posting.

At operation 540, upsell module 208 can prefill job information for the paid job posting based on information from the unpaid job posting. The prefill job information can be reviewed by the identified member before the paid job listing is created.

According to various example embodiments, one or more of the methodologies described herein may facilitate the determination of members with hiring authority that are viewing an unpaid job posting.

When these effects are considered in aggregate, one or more of the methodologies described herein may obviate a need for certain human efforts or resources that otherwise would be involved in determining owners of job postings. Additionally, computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 6 is a block diagram illustrating components of a machine 600, according to some example embodiments, able to read instructions 624 from a machine-readable medium 622 (e.g., a non-transitory machine-readable medium, a machine-readable storage medium, a computer-readable storage medium, or any suitable combination thereof) and perform any one or more of the methodologies discussed herein, in whole or in part. Specifically, FIG. 6 shows the machine 600 in the example form of a computer system (e.g., a computer) within which the instructions 624 (e.g., software, a program, an application, an applet, an app, or other executable code) for causing the machine 600 to perform any one or more of the methodologies discussed herein may be executed, in whole or in part.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a distributed (e.g., peer-to-peer) network environment. The machine 600 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include any collection of machines that individually or jointly execute the instructions 624 to perform all or part of any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or another pointing instrument), a storage unit 616, an audio generation device 618 (e.g., a sound card, an amplifier, a speaker, a headphone jack, or any suitable combination thereof), and a network interface device 620.

The storage unit 616 includes the machine-readable medium 622 (e.g., a tangible and non-transitory machine-readable storage medium) on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered machine-readable media (e.g., tangible and non-transitory machine-readable media). The instructions 624 may be transmitted or received over the network 190 via the network interface device 620. For example, the network interface device 620 may communicate the instructions 624 using any one or more transfer protocols (e.g., Hypertext Transfer Protocol (HTTP)).

In some example embodiments, the machine 600 may be a portable computing device, such as a smartphone or tablet computer, and have one or more additional input components 630 (e.g., sensors or gauges). Examples of such input components 630 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 624 for execution by the machine 600, such that the instructions 624, when executed by one or more processors of the machine 600 (e.g., processor 602), cause the machine 600 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing job listing data from a limited job posting of an employer, the job listing data having a job feature, a job activity, and a company feature;
accessing member data from a social network system, the member data having a social graph data and member behavior data;
determining, using a determination module having a processor, a value for the limited job posting based on the accessed job listing data and the accessed member data;
generating job application data for the limited job posting when the determined value is above a predetermined threshold, the job application data having upsell information for a premium job posting associated with the limited job posting; and
displaying the job application data.

2. The method of claim 1, wherein the limited job posting is an unpaid job posting and the premium job posting is a paid job posting.

3. The method of claim 1, wherein a number of paid job posting are prepaid by the employer, and the predetermined threshold is based on a number of empty slots available from the number of paid job posting.

4. The method of claim 1, wherein the upsell information includes an expected number of page views for the premium job posting, and an expected number of applicants applying to the premium job posting.

5. The method of claim 1, wherein the upsell information includes a percentage increase page views when upgrading the limited job posting to the premium job posting.

6. The method of claim 1, wherein the upsell information includes a percentage increase of applicants applying when upgrading the limited job posting to the premium job posting.

7. The method of claim 1, wherein the predetermined threshold is based on the job listing data.

8. The method of claim 1, wherein the predetermined threshold is based on a brand index associated with the employer, a standardized job title associated with the limited job posting, and a location associated with the limited job posting.

9. The method of claim 1, wherein the job feature includes a country associated with the job posting, a region associated with the job posting, a standardized job title, and a job function.

10. The method of claim 1, wherein the job activity includes job application information, a job apply feature, a job impression feature, and a number of page views for the job posting. (explain each feature)

11. The method of claim 1, wherein the company feature includes a number of employees associated with the employer and industry of the employer.

12. The method of claim 1, wherein the company feature is a brand index, and wherein the brand index is based on a number of followers for the employer, a number of page views for a company page in the social network system associated with the employer, or a number page views for a job page in the social network system associated with the employer.

13. The method of claim 1, wherein the company feature is a brand index, and wherein the brand index is based on a number of profile views for a member profile in the social network system associated with the employer.

14. The method of claim 1, wherein the social graph data includes a number of connections for members in the social network system associated with the employer.

15. The method of claim 1, wherein the member behavior data includes content viewed in the social network system by a member of the social network system.

16. The method of claim 15, wherein the member has applied to another job listing having a similar job feature as the job feature from the job listing data.

17. The method of claim 1, wherein the member behavior data includes email links selected in the social network system by a member of the social network system.

18. A system comprising:
an access module configured to:
access job listing data from a limited job posting of an employer, the job listing data having a job feature, a job activity, and a company feature;
access member data from a social network system, the member data having a social graph data and member behavior data;
a determination module configured to determine a value for the limited job posting based on the accessed job listing data and the accessed member data;
an upsell module configured to generate job application data for the limited job posting when the determined value is above a predetermined threshold, the job application data having upsell information for a premium job posting associated with the limited job posting; and
a display module configured to display the job application data.

19. The system of claim 19, wherein the upsell information includes an expected number of page views for the premium job posting, and an expected number of applicants applying to the premium job posting.

20. A non-transitory machine-readable storage medium comprising instructions that, when executed by one or more processors of a machine, cause the machine to perform operations comprising:
accessing job listing data from a limited job posting of an employer, the job listing data having a job feature, a job activity, and a company feature;
accessing member data from a social network system, the member data having a social graph data and member behavior data;
determining a value for the limited job posting based on the accessed job listing data and the accessed member data;
generating job application data for the limited job posting when the determined value is above a predetermined threshold, the job application data having upsell information for a premium job posting associated with the limited job posting; and
displaying the job application data.
